(19) United States
(12) Patent Application Publication
(10) Pub. No.: US 2002/0068142 A1
(43) Pub. Date: Jun. 6, 2002

(54) Pop-up wipe dispensing system

(75) Inventors: Dario Baroni, Pisa (IT); Gianluca Costa, Taranto (IT)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 09/887,419

(22) Filed: Jun. 22, 2001

(30) Foreign Application Priority Data
Jun. 23, 2000 (EP) 00870143.5

(51) Int. Cl. B32B 3/04

(52) U.S. Cl. 428/43; 428/126

(57) ABSTRACT

The present application relates to a POP-UP wipe dispensing system, comprising a particular wipe folding pattern. The wipes are preferably packaged into a container, which has smaller length and width dimensions than that of the wipe.

### TECHNICAL FIELD

The present invention relates a wet or dry wipe and a pop-up wipe dispensing system to allow easier dispensing of the wipe. The wipes are designed to be suitable for any application. In a particularly preferred embodiment the wipe is pre-moistened with a cleaning composition and is used to clean hard surfaces, such as kitchen or bathroom surfaces, including the lavatory.

### BACKGROUND

Disposable, man-made, synthetic and/or natural fiber-based, pre-moistened or substantially dry cleaning wipes are known in the prior art. Disposable cleaning wipes are those that are specifically designed so as to be used once and then discarded. The wipes may be constructed from a web comprising a variety of different materials. Such materials may include synthetic, man-made and natural fibres, such as polyolefin fibres, viscose fibres, cotton fibres, which are generally moistened with an aqueous or non-aqueous cleaning composition which may contain amongst others surfactants, polymers, disinfecting agents, preservatives, oils and scents depending on the end use envisaged.

Wipes can be either pre-moistened or substantially dry. Substantially dry wipes are typically disposable towelettes which are primarily used to absorb water or other fluids from surfaces. Alternatively dry wipes may comprise a powder or gel composition, for example a cleaning or cleansing composition, that becomes active on wetting. Such wipes can then be used in a similar way to wet wipes. Pre-moistened or wet wipes, as they are also known, typically comprise a liquid composition and thus may be utilised in a variety of applications, both domestic and industrial and perform a variety of functions. Wipes are commonly used for human cleansing and wiping such as face and hand cleansing and anal, perineal and genital cleansing, for example as intimate hygiene wipes, such as feminine wet wipes. Wet wipes may also be used for application of substances to the body including removing and applying of make-up, skin conditioners and medications. Another application of wipes is during diaper changes and also for the treatment of adult and baby dermatitis partly caused by the use of diapers and incontinence devices. Wet wipes may also include articles used for the cleaning or grooming of pets. One particularly preferred application for wet wipes is wiping and/or cleaning of hard surfaces and the application of compositions to surfaces, for example kitchen and especially bathroom surfaces, spectacles, shoes and surfaces which require cleaning in industry, for example surfaces of machinery or vehicles.

Wipes, especially wet wipes have become increasingly popular over recent years. This is believed to be mainly due to the convenience of use of the wipe. The user no longer has to load a sponge or cloth with a composition and no longer has to be concerned with using the correct dose. The wipe provide a implement which can be used to clean or wipe surfaces or skin immediately on removal from the packaging. Wipes are typically presented to the user in a container comprising a stack of wipes, which can be resealed after each use in order to protect the remaining wipes. In one typical arrangement each wipe is independently folded and stacked in a pile. However such a system of merely folding and stacking on top of one another provides the user with no means of feeding out consecutive wipes or facilitating grasping of the next wipe in the stack. This system thus requires the user to find a free edge of the exposed wipe and peel the wipe from the remaining stack of wipes. This procedure is time consuming, frustrating and can require dexterity which might not be available to older or younger users.

To overcome these problems manufacturers of wipes have devised ways of dispensing the wipes by feeding the next wipe in the stack though the opening of the container to facilitate grip by the user. Such dispensing systems are commonly known as ‘pop-up’ dispensers, wherein a trailing edge or portion of the wipe being extracted from the container, draws the next wipe in the stack through the opening of the container, then typically detaches from the trailing edge or portion of the wipe leaving the leading edge or portion of the next wipe freely accessible for the user. One method of pop-up dispensing can be achieved from a continuous roll of wipe substrate, see for example U.S. Pat. No. 3 868 052, where the wipes are peeled from the inside of the roll and fed through the opening of the container. This system is known as a roll-up dispensing system. This stacking arrangement however have a higher dispensing force requirement than discrete wipes, as the perforated region must have sufficient structural integrity to prevent premature separation. Furthermore, higher force requirements also means that it is more difficult for the user to detach the wipe from the next wipe and sometimes requires the use of both hands, one to pull on the container and one to pull on the wipe. Such dispensing arrangements and the higher dispensing forces for separation, also often causes the leading edge or portion of the next wipe to protrude further beyond the opening of the container, causing difficulty in closing and resealing the container and excessive drying of the wipes, especially the wipe that protrudes from the container. Higher separation forces may also lead to the user removing more wipes from the container than required causing unnecessary wastage, this is known as chaining.

Another pop-up dispensing system involves folding the wipes such that the perforations in one wipe are spaced intermediate the perforations of the next wipe. The wipes are then accordion or zig-zag folded inside a container. Thus when the top wipe is pulled from the box, the next wipe is pulled with it and then can be detached from the next wipe again using dispensing forces of separation.

One further approach to pop-up dispensing uses discrete, folded and interleaving wipes. The wipes are interfolded such that they have overlapping edge portions which are substantially parallel to each other and which adhere to one another such that the next wipe is fed through the opening of the container when the first wipe is removed. This method whilst solving any problem relating to dispensing forces used, can result in chaining, where separation does not take place, or fall back, where adhesion is not sufficient enough to result in the next wipe being fed through the opening of the container.

A further problem the Applicant has encountered with all of the above dispensing systems is that whilst the wipes must be large enough to perform the task required, they must be folded into a container which is small enough to be easily stowed in the kitchen or bathroom or carried with the user in a bag or pocket etc without being cumbersome. In a particular embodiment of the present invention the wipes are designed to be used to clean bathroom surfaces, especially lavatories and can then be safely flushed. It is therefore preferred that the container, containing the wipes is of small enough size such that it can be stored in the bathroom, preferably on top of the lavatory cistern and thus within easy reach. Wipes folded using the zig-zag or interleaving folding patterns must be packaged into containers that are approximately the width of the wipe. The Roll-up dispensing system, whilst allowing the wipes to be packaged into small containers, presents other problems, for example increased separation force, chaining and three dimensional stability of the roll, especially once the roll is depleted. Moreover when dispensing wet wipes, the wipe tends to fold inwards resulting in adhesion of the wipe to itself, making it difficult for the user to unfold and use the wipe effectively.

The present invention thus relates to a new pop-up dispensing system for dispensing, preferably wet wipes. The wipes of the present invention are joined by connecting sections to make a continuous length of substrate. The length of substrate is then folded in such a way as to allow the manufacturer to pack the substrate into a container having length and width dimensions which are smaller than those of the unfolded wipe. The wipes are thus folded across their longitudinal directional and cross directional.

### SUMMARY OF THE INVENTION

According to the present invention there is provided a continuous length of substrate comprising a plurality of wipes suitable for use in a pop-up dispensing system, each wipe comprising two opposing sides and two opposing ends joining said two opposing sides, said wipes having a longitudinal direction which extends between said sides and a cross direction which is perpendicular to the longitudinal direction, each wipe being connected to the subsequent wipe by a connecting section defined by a tear perforation pattern, characterised in that the length of substrate is folded in the longitudinal direction and then in the cross direction in a zig-zag, overlaid, pattern to define a stack of wipes.

In another aspect of the present invention there is provided a POP-UP wipe dispensing system comprising a container which comprises a dispensing orifice, and a length of substrate according to the paragraph above.

### DETAILED DESCRIPTION

### Substrate

The substrate of the present invention is present as a continuous length of substrate, 1. The length of substrate is partitioned into a plurality of wipes, 2, that are connected to each other by connecting sections,3, and the connecting sections are defined by a tear perforation pattern.

As discussed above it is the aim of the present invention to pack the wipes into a container having length and width dimensions which are smaller than those of the unfolded wipe. The length of substrate must therefore be folded. However folding in one direction only, as has been done in the prior art, does not sufficiently reduce the size (cross sectional area) of the wipe to pack it into the required container size. The Applicants have thus devised a new folding pattern which includes folding the wipe in at least two dimensions but which are still pop-up, providing the user free access to a leading edge or portion of the next wipe.

The continuous length of substrate comprises a plurality of wipes and each wipe comprises two opposing sides, 4, and two opposing ends, 5 which join the two opposing sides, 4. The longitudinal direction, 8, of the wipe is the direction which extends between the sides. The longitudinal direction is also often known as the machine direction as it is the direction in which the substrate moves through the manufacturing machine. The cross direction, 9, is the direction which is perpendicular to the longitudinal direction, 8. The folding pattern of the present invention requires that the length of substrate is first folded in the longitudinal direction down the entire length of the substrate. The longitudinally folded substrate is then cross folded in a zig-zag overlaid, pattern to define a stack of wipes. Preferably the length of substrate is folded in the longitudinal direction using folding patterns selected from the Z, V and C folding patterns. The Z, V and C folding patterns are known in the art, but basically describe the shape of the fold made in the longitudinal direction. For example, as can be seen from FIG. 2 , the Z folding pattern consists of folding the opposing side of the wipe in different directions, one side being folded upwards and the other being folded downwards, leaving a section in between that has not been folded, thereby producing a Z shape. As can be seen from FIG. 3 , the V folding pattern consists of folding one of the opposing sides of the substrate toward the other side, forming a V shape. As can be seen from FIG. 4 , the C folding pattern consists of folding both opposing sides in the same direction (i.e. either upwards or downwards), leaving a section in the middle of the wipe which is not folded, forming a C shape.

Zig-Zag overlaid folding, FIG. 5 , consists of folding the length of substrate in the cross direction such that the wipes are folded first in one cross direction, then back in the opposing cross direction and then again in the first cross direction e.t.c. to define a stack of wipes. In a preferred embodiment the length of substrate is folded such that the perforations or connecting sections of the wipes are positioned in a midpoint between the front and back of the stack of wipes. Alternatively the perforations or connecting sections may be positioned at a fold.

In a particularly preferred embodiment the length of substrate is first folded in the longitudinal direction using the Z folding pattern and then in the cross direction using the zig-zag, overlaid, pattern as seen in FIG. 6 .

The connecting sections, 3, of the successive wipes are defined by a pattern of perforations which extend across the length of substrate. In a preferred embodiment the perforation pattern comprises a number of slits in the substrate, leaving small sections of connection of successive wipes. The line of perforation may traverse the substrate in the cross direction in a substantially straight line. Alternatively the line of perforations may be for example, curved or ‘V’ shaped. Where the line of perforation is curved or ‘V’ shaped, the fee end of the wipe, accessible to the user is the tip of the curve or ‘V’ making the wipe even more accessible. In a particularly preferred embodiment the perforation pattern is such that the ratio of connecting sections to slits is less than 50%, more preferably less than 10%.

The substrate is preferably provided by a web, typically as a sheet of material cut from the web. The web may be woven or non-woven, foam, sponge, battings, balls, puffs or films. Most preferably the web is non-woven and comprises man-made fibers, even more preferably the web comprises solely man-made fibres.

According to the present invention the web may be produced by any method known in the art. For example non-woven material substrates can be formed by dry forming techniques such as carding, air-laying or wet laying, such as on a paper making machine. Other non-woven manufacturing techniques such as melt blown, spun bonded, needle punched, spun laced may also be used. Preferably the web used in the present invention is produced using the carding method, during which entangled fibrous mats are transformed into parallel fibrous webs.

While various embodiments of a web, to provide a substrate, are within the scope of the present invention and are detailed below, in a preferred embodiment the web is carded and non-woven comprising man-made fibres. In a preferred embodiment the web comprises at least 80%, even more preferably at least 95% and most preferably approximately 100% man-made fibres.

Man-made fibres, as used herein, includes fibres manufactured from cellulose, for example derivatives of or regenerated cellulose and thus are distinguishable from synthetic fibres, which are based on synthetic organic polymers. A derivative fibre, as used herein, is a fibre formed when a chemical derivative of a natural polymer, e.g., cellulose, is prepared, dissolved, and extruded as a continuous filament, and the chemical nature of the derivative is retained after the fibre formation process. A regenerated fibre, as used herein, is a fibre formed when a natural polymer, or its chemical derivative, is dissolved and extruded as a continuous filament. Whilst the physical nature of the natural polymer is changed, the chemical nature of the natural polymer is substantially retained or regenerated after the fibre formation process. Preferred man-made fibres have a denier of 0.5 dtex to 3.0 dtex, more preferably of 1.0 dtex to 2.0 dtex, most preferably of 1.5 dtex to 2.0 dtex.

Preferred man-made fibres used in the present invention include rayon (viscose) that is produced by dissolving cellulose fibres in N-methylmorpholine-N-oxide, resulting in what is known as regenerated cellulosic fibres and which are supplied by Tencel Fibres Europe, UK.

Man-made fibres are preferred fibres for use in webs of the present invention due to their high consumer acceptance and their cheap and typically ecological production. Man-made fibres and in particular cellulose derived man-made fibres, are known to exhibit high biodegradability, however it had not previously been realised that webs made entirely or substantially entirely of man-made fibres could be suitable for use as a wet wipe substrate. Wet wipes composed of man-made fiber web substrates provide further advantages in that the fibres used can also be chemically or physically altered during the fiber formation process so as to comprise further advantageous benefits such as softness, roughness and absorbency.

The web preferably has a weight of at least 20 gm⁻² and preferably less than 150 gm⁻², and most preferably the base weight is in the range of 20 gm⁻² to 100 gm⁻², more preferably from 40 gm⁻² to 70 gm⁻². The web may have any caliper. Typically, when the web is made by an air laying process, the average web caliper is less than 1.0 mm. More preferably the average caliper of the web is from 0.2 mm to 0.9 mm. The web caliper is measured according to standard EDANA Non-woven Industry Methodology, reference method # 30.4-89.

In addition to the fibres used to make the web, the web can comprise other components or materials added thereto as known in the art, to improve appearance, surface texture, colour, and odour. An example is the use of opacifying agents, for example titanium dioxide.

In order to achieve the adequate strength of the wet wipe substrate, the fibres are hydroentangled. Hydroentanglement is a process whereby fibers of the web are rearranged and entangled by means of fluid forces. Hydroentanglement can in this way be used as a bonding means, repositioning and entangling individual fibers into configurations that bring about frictional interlocking at the fiber level. In addition to the bonding benefits, hydroentanglement can also be used to provide surface texturing, whereby hydroentanglement repositions fibers into open-patterned arrangements. Webs that have undergone a hydroentanglement treatment, contain no chemical binders, and have not been thermally bonded. Hydroentangled non-woven webs are mechanically strong, can withstand stretching, pulling and abrasion, but can are be made to be tactil and soft. Furthermore the absorbency and wetting cpability of the web is not adversely affected by the hydroentanglement process.

Hence according to the present invention the substrate of the most preferred embodiment is composed of substantially 100% hydroentangled man-made regenerated cellulosic fibres.

According to a preferred embodiment of the present invention the substrate incorporates a composition as described herein. By “incorporates” it is meant herein that said substrate or wet wipe is coated or impregnated with a preferably liquid composition as described herein.

In preparing wet wipes according to the present invention, the composition is applied to at least one surface of the substrate material. The composition can be applied at any time during the manufacture of the wet wipe. Preferably the composition can be applied to the substrate after the substrate has been dried. Any variety of application methods that evenly distribute lubricious materials having a molten or liquid consistency can be used. Suitable methods include spraying, printing, (e.g. flexographic printing), coating (e.g. gravure coating or flood coating) extrusion whereby the composition is forced through tubes in contact with the substrate whilst the substrate passes across the tube or combinations of these application techniques. For example spraying the composition on a rotating surface such as calender roll that then transfers the composition to the surface of the substrate. The composition can be applied either to one surface of the substrate or both surfaces, preferably both surfaces. The preferred application method is extrusion coating.

The composition can also be applied uniformly or non uniformly to the surfaces of the substrate. By non uniform it is meant that for example the amount, pattern of distribution of the composition can vary over the surface of the substrate. For example some of the surface of the substrate can have greater or lesser amounts of composition, including portions of the surface that do not have any composition on it. Preferably however the composition is uniformly applied to the surfaces of the wipes.

Preferably, the composition can be applied to the substrate at any point after it has been dried. For example the composition can be applied to the substrate preferably after calendering and prior to being wound up onto a parent roll. Typically, the application will be carried out on a substrate unwound from a roll having a width equal to a substantial number of wipes it is intended to produce. The substrate with the composition applied thereto is then subsequently perforated utilising standard techniques in order to produce the desired perforation line. Alternatively the substrate may be unwound from a roll, perforated to form wipes of the correct size, folded and then the composition is applied to the substrate.

### Container

The container according to the present invention is a box, tub, pouch or other any suitable receptacle for wipes. The container preferably comprises bottom, top and side walls. In a preferred embodiment the container is refillable and as such comprises a container lid, which may then form the bottom or top wall of the container. Alternatively the container may be a flexible pouch comprising a resealable strip dispensing opening. The container may be any suitable shape for the purpose, but is preferably a rectangular parallelpiped. The container can be made using any suitable material, but is preferably made from plastic.

The container according to the present invention comprises a dispensing orifice. The dispensing orifice may be located in any of the walls, but preferably is located in the top wall of the container. In this embodiment the container lid where present, preferably forms the bottom wall of the container. The dispensing orifice can be of any suitable shape. Preferably the dispensing orifice comprises a shape which aids the separation of a wipe from the subsequent wipe. In an even more preferred embodiment the dispensing orifice also aids the unfolding of the wipe. Examples of suitable dispensing orifices are shown in FIG. 7a to l . In a preferred embodiment the dispensing orifice also comprises a lid, the dispensing lid. Either lid, where present preferably provides a seal, retaining moisture and delaying drying of the wipe before use. The dispensing lid is preferably equipped with an easy release button, which when activated by for example pressing or any other interaction by the user, releases the dispensing lid, providing access to the wipes. In a further preferred embodiment the dispensing lid comprises a hinge.

In a particularly preferred embodiment the wipes are located in a pouch which is designed to fit inside the container. The pouch can thus be sold as a wipes refill package, that the consumer would then store in the container. The pouch is thus removable and preferably flexible in order to allow installation and removal of the pouch from the container. The pouch is also preferably resealable.

### Composition

The wipes according to the present invention preferably are wet wipes and incorporate a composition. The composition of the present invention may be formulated comprising any ingredient which is suitable for the application for which the wipes will be used.

The compositions may be formulated in any suitable form for example as a solid, paste or liquid. In the case where the compositions according to the present invention are formulated as solids, they can be applied to the substrate as a solid or alternatively can be mixed with an appropriate solvent, typically water, before application to the substrate. Where the composition is in liquid form, the compositions are preferably but not necessarily formulated as aqueous compositions. Liquid compositions are preferred herein for convenience of use.

In a preferred embodiment the liquid compositions according to the present invention are aqueous compositions typically comprising from 50% to 99.9% by weight of the total composition of water, preferably from 70% to 99% and more preferably from 80% to 99%. These aqueous compositions preferably have a pH as is of not more than 13.0, more preferably from 1 to 11, and most preferably from 2 to 10. The pH of the compositions can be adjusted by using organic or inorganic acids, or alkalinising agents.

Compositions may have any suitable pH depending on the intended application of the wipes. In a preferred embodiment of the present invention the composition is a cleaning composition and is preferably suitable for cleaning and/or disinfecting. Hence in this preferred embodiment the cleaning composition preferably has pH in the range of from 5 to 13, more preferably from 7 to 13 and most preferably from 8 to 10. Compositions for use as disinfecting compositions preferably have a pH in the range of from 0 to 7, more preferably from 1 to 5 and most preferably from 2 to 4.

The cleaning compositions herein may comprise a variety of ingredients including, but not limited to peroxygen bleach, disinfecting components, organic acids, surfactants, chelants, solvents, builders, stabilisers, bleach activators, soil suspenders, dye transfer agents, brighteners, perfumes, anti dusting agents, enzymes, dispersant, dye transfer inhibitors, pigments, perfumes, moisturisers, radical scavengers, pH buffers, dyes or mixtures thereof.

### Surfactant System

According to the present invention the substrate preferably incorporates a composition comprising a surfactant system. The surfactant system consists of a synergistic system comprising at least three surfactants, namely an anionic, a nonionic and an amphoteric and/or zwitterionic surfactant.

The compositions preferably comprises the surfactant system at a level by weight of the total composition of from 0.05-20%, more preferably from 0.1-5% and most preferably from 0.2-3%.

### Anionic Surfactant

Suitable anionic surfactants for use herein include alkyl sulphates. Suitable alkyl sulphates for use herein include water-soluble salts or acids of the formula ROSO₃M wherein R is a C₆-C₂₄ linear or branched, saturated or unsaturated alkyl group, preferably a C₈-C₂₀ alkyl group, more preferably a C₈-C16 alkyl group and most preferably a C₁₀-C14 alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable anionic surfactants for use herein further include alkyl aryl sulphates. Suitable alkyl aryl sulphates for use herein include water-soluble salts or acids of the formula ROSO₃M wherein R is an aryl, preferably a benzyl, substituted by a C₆-C₂₄ linear or branched saturated or unsaturated alkyl group, preferably a C₈-C20 alkyl group and more preferably a C₁₀-C₁₆ alkyl group and M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable anionic surfactants for use herein further include alkoxylated sulphate surfactants. Suitable alkoxylated sulphate surfactants for use herein are according to the formula RO(A)ₘSO₃M wherein R is an unsubstituted C₆-C₂₄ alkyl, hydroxyalkyl or alkyl aryl group, having a linear or branched C₆-C₂₄ alkyl component, preferably a C₁₂-C₂₀ alkyl or hydroxyalkyl, more preferably C₁₂-C₁₈ alkyl or hydroxyalkyl, A is an ethoxy or propoxy or butoxy unit or a mixture thereof, m is greater than zero, typically between 0.5 and 6, more preferably between 0.5 and 3, and M is H or a cation which can be, for example, a metal cation (e.g., sodium, potassium, lithium, calcium, magnesium, etc.), ammonium or substituted-ammonium cation. Alkyl ethoxylated sulphates, alkyl butoxylated sulphates as well as alkyl propoxylated sulphates are contemplated herein. Specific examples of substituted ammonium cations include methyl-, dimethyl-,trimethyl-ammonium and quaternary ammonium cations, such as tetramethyl-ammonium, dimethyl piperdinium and cations derived from alkanolamines such as ethylamine, diethylamine, triethylamine, mixtures thereof, and the like. Exemplary surfactants are C₁₂-C₁₈ alkyl polyethoxylate (1.0) sulphate (C₁₂-C₁₈E(1.0)SM), C₁₂-C₁₈ alkyl polyethoxylate (2.25) sulphate (C_{12-C}₁₈E(2.25)SM), C₁₂-C₁₈ alkyl polyethoxylate (3.0) sulphate (C₁₂-C₁₈E(3.0)SM), and C₁₂-C₁₈ alkyl polyethoxylate (4.0) sulphate (C₁₂-C₁₈E(4.0)SM), wherein M is conveniently selected from sodium and potassium.

Suitable anionic surfactants for use herein further include alkyl sulphonates. Suitable alkyl sulphonates for use herein include water-soluble salts or acids of the formula RSO₃M wherein R is a C₆-C₂₀ linear or branched, saturated or unsaturated alkyl group, preferably a C₈-C₁₈ alkyl group and more preferably a C₁₄-C₁₇ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable anionic surfactants for use herein further include alkyl aryl sulphonates. Suitable alkyl aryl sulphonates for use herein include water-soluble salts or acids of the formula RSO₃M wherein R is an aryl, preferably a benzyl, substituted by a C₆-C₂₀ linear or branched saturated or unsaturated alkyl group, preferably a C₈-C₁₈ alkyl group and more preferably a C₉-C₁₄ alkyl group, and M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable alkyl sulphonates include C₁₄-C₁₇ paraffin sulphonate like Hostapur ® SAS commercially available from Hoechst. An example of commercially available alkyl aryl sulphonate is Lauryl aryl sulphonate from Su.Ma.. Particularly preferred alkyl aryl sulphonates are alkyl benzene sulphonates commercially available under trade name Nansa® available from Albright&Wilson.

Suitable anionic surfactants for use herein further include alkoxylated sulphonate surfactants. Suitable alkoxylated sulphonate surfactants for use herein are according to the formula R(A)ₘSO₃M wherein R is an unsubstituted C₆-C₂₀ alkyl, hydroxyalkyl or alkyl aryl group, having a linear or branched C₆-C₂₀ alkyl component, preferably a C₁₂-C₂₀ alkyl or hydroxyalkyl, more preferably C₁₂-C₁₈ alkyl or hydroxyalkyl, A is an ethoxy or propoxy or butoxy unit, m is greater than zero, typically between 0.5 and 6, more preferably between 0.5 and 3, and M is H or a cation which can be, for example, a metal cation (e.g., sodium, potassium, lithium, calcium, magnesium, etc.), ammonium or substituted-ammonium cation. Alkyl ethoxylated sulphonates, alkyl butoxylated sulphonates as well as alkyl propoxylated sulphonates are contemplated herein. Specific examples of substituted ammonium cations include methyl-, dimethyl-,trimethyl-ammonium and quaternary ammonium cations, such as tetramethyl-ammonium, dimethyl piperdinium and cations derived from alkanolamines such as ethylamine, diethylamine, triethylamine, mixtures thereof, and the like. Exemplary surfactants are C₁₂-C₁₈ alkyl polyethoxylate (1.0) sulphonate (C₁₂-C₁₈E(1.0)SM), C₁₂-C₁₈ alkyl polyethoxylate (2.25) sulphonate (C₁₂-C₁₈E(2.25)SM), C₁₂-C₁₈ alkyl polyethoxylate (3.0) sulphonate (C₁₂-C₁₈E(3.0)SM), and C₁₂-C₁₈ alkyl polyethoxylate (4.0) sulphonate (C₁₂-C₁₈E(4.0)SM), wherein M is conveniently selected from sodium and potassium. Particularly suitable alkoxylated sulphonates include alkyl aryl polyether sulphonates like Triton X-200® commercially available from Union Carbide.

Suitable anionic surfactants for use herein further include C₆-C₂₀ alkyl alkoxylated linear or branched diphenyl oxide disulphonate surfactants. Suitable C₆-C₂₀ alkyl alkoxylated linear or branched diphenyl oxide disulphonate surfactants for use herein are according to the following formula:

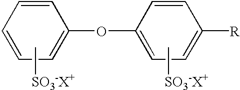

wherein R is a C₆-C₂₀ linear or branched, saturated or unsaturated alkyl group, preferably a C₆-C₁₈ alkyl group and more preferably a C₆-C₁₄ alkyl group, and X+ is H or a cation, e.g., an alkali metal cation (e.g., sodium, potassium, lithium, calcium, magnesium and the like). Particularly suitable C₆-C₂₀ alkyl alkoxylated linear or branched diphenyl oxide disulphonate surfactants to be used herein are the C₁₂ branched di phenyl oxide disulphonic acid and C₁₆ linear di phenyl oxide disulphonate sodium salt respectively commercially available by DOW under the trade name Dowfax 2A1® and Dowfax 8390®.

Other suitable anionic surfactants for use herein include alkyl-carboxylates. Other anionic surfactants can include salts (including, for example, sodium, potassium, ammonium, and substituted ammonium salts such as mono-, di- and triethanolamine salts) of soap, C₈-C₂₄ olefinsulfonates, sulfonated polycarboxylic acids prepared by sulfonation of the pyrolyzed product of alkaline earth metal citrates, e.g., as described in British patent specification No. 1,082,179; acyl glycerol sulfonates, fatty oleyl glycerol sulfates, alkyl phenol ethylene oxide ether sulfates, alkyl phosphates, isethionates such as the acyl isethionates, N-acyl taurates, alkyl succinamates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), acyl sarcosinates, sulfates of alkylpolysaccharides such as the sulfates of alkylpolyglucoside (the nonionic nonsulfated compounds being described below), branched primary alkyl sulfates, alkyl polyethoxy carboxylates such as those of the formula RO(CH₂CH₂O)ₖCH₂COO-M⁺ wherein R is a C₈-C₂₂ alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No.3,929,678, issued Dec. 30, 1975 to Laughlin, et al. at Column 23, line 58 through Column 29, line 23.

In one preferred embodiment, preferred anionic surfactants for use herein are the C8-C16 alkyl sulfonates, C8-C16 alkyl sulfates, including branched alkyl sulphates, C8-C16 alkyl alkoxylated sulfates (e.g., C8-C16 alkyl ethoxylated sulfates), C8-C16 alkyl alkoxylated sulphonates and mixtures thereof. Such anionic surfactants are preferred herein as it has been found that they contribute to the disinfecting properties of a disinfecting composition herein. For example, C8-C16 alkyl sulfate acts by disorganizing the bacteria cell membrane, inhibiting enzymatic activities, interrupting the cellular transport and/or denaturing cellular proteins. Indeed, it is speculated that the improved disinfecting performance further associated with the addition of an anionic surfactant, especially a C8-C16 alkyl sulfonate, a C8-C16 alkyl sulfate and/or a C8-C16 alkyl alkoxylated sulfate, in a composition according to the present invention, is likely due to multiple mode of attack of said surfactant against the bacteria.

In a second preferred embodiment, the anionic surfactant is selected from the group consisting of: C₆₋₂₄ alkyl sulphates; C₆₋₂₄ alkyl aryl sulphates; C₆₋₂₄ alkyl alkoxylated sulphates; C₆₋₂₄ alkyl sulphonates, including paraffin sulphonates; C₆₋₂₄ alkyl aryl sulphonates; C₆₋₂₄ alkyl alkoxylated sulphonates; C₆-C₂₄ alkyl alkoxylated linear or branched diphenyl oxide disulphonates; naphthalene sulphonates; and mixtures thereof. More preferably the anionic surfactant is selected from the group consisting of: C₆₋₂₄ alkyl sulphonates; C₆₋₂₄ alkyl sulphates; C₆₋₂₄ alkyl alkoxylated sulphates; C₆₋₂₄ alkyl aryl sulphonates; and mixtures thereof. Even more preferably the anionic surfactant for use herein is a paraffin sulphonate. Most preferably the anionic surfactant for use herein is a C₁₄-C₁₇ paraffin sulphonate.

In a third preferred embodiment the anionic surfactant is a branched alkyl sulphate surfactant. Branched alkyl sulphate is herein defined to mean a an alkyl sulfate comprising a sulfate group and a carbon chain of preferably from 2 to 20, more preferably from 2 to 16, most preferably from 2 to 8 carbon atoms. The carbon chain of the branched alkyl sulfate comprises at least one branching group attached to the carbon chain. The branching group is selected from the group consisting of an alkyl group having from 1 to 20, more preferably from 1 to 10 and most preferably from 1 to 4 carbon atoms. The branching group may be located at any position along the alkyl chain of the branched alkyl sulfate. More preferably the branching group is located at position from 1 to 4 along the alkyl chain. The sulfate group can be at any point along the length of the alkyl chain, most preferable at a terminus.

Suitable preferred branched alkyl sulfates include those available from Albright & Wilson under the tradename Empicol 0585/A.

### Nonionic Surfactant

Suitable nonionic surfactants for use herein are fatty alcohol ethoxylates and/or propoxylates which are commercially available with a variety of fatty alcohol chain lengths and a variety of ethoxylation degrees. Indeed, the HLB values of such alkoxylated nonionic surfactants depend essentially on the chain length of the fatty alcohol, the nature of the alkoxylation and the degree of alkoxylation. Surfactant catalogues are available which list a number of surfactants, including nonionics, together with their respective HLB values. Preferred nonionic surfactants for one embodiment are those having an average HLB from 8 to 20, more preferably from 10 to 18, most preferably from 11 to 16. These hydrophobic nonionic surfactants have been found to provide good grease cutting properties.

Preferred hydrophobic nonionic surfactants for use in the compositions according to the present invention are surfactants having an HLB below 16 and being according to the formula RO—(C₂H₄O)ₙ(C₃H₆O)ₘH, wherein R is a C₆ to C₂₂ alkyl chain or a C₆ to C₂₈ alkyl benzene chain, and wherein n+m is from 0 to 20 and n is from 0 to 15 and m is from 0 to 20, preferably n+m is from 1 to 15 and, n and m are from 0.5 to 15, more preferably n+m is from 1 to 10 and, n and m are from 0 to 10. The preferred R chains for use herein are the C₈ to C₂₂ alkyl chains. Accordingly, suitable hydrophobic nonionic surfactants for use herein are Dobanol® 91-2.5 (HLB=8.1; R is a mixture of C9 and C₁₁ alkyl chains, n is 2.5 and m is 0), or Lutensol® TO3 (HLB=8; R is a C₁₃ alkyl chains, n is 3 and m is 0), or Lutenso® AO3 (HLB=8; R is a mixture of C₁₃ and C₁₅ alkyl chains, n is 3 and m is 0), or Tergitol® 25L3 (HLB=7.7; R is in the range of C₁₂ to C₁₅ alkyl chain length, n is 3 and m is 0), or Dobanol® 23-3 (HLB=8.1; R is a mixture of C₁₂ and C₁₃ alkyl chains, n is 3 and m is 0), or Dobanol® 23-2 (HLB=6.2; R is a mixture of C₁₂ and C₁₃ alkyl chains, n is 2 and m is 0), or Dobanol® 45-7 (HLB=11.6; R is a mixture of C₁₄ and C₁₅ alkyl chains, n is 7 and m is 0) Dobanol® 23-6.5 (HLB=11.9; R is a mixture of C₁₂ and C₁₃ alkyl chains, n is 6.5 and m is 0), or Dobanol® 25-7 (HLB=12; R is a mixture of C₁₂ and C₁₅ alkyl chains, n is 7 and m is 0), or Dobanol® 91-5 (HLB=11.6; R is a mixture of C₉ and C₁₁ alkyl chains, n is 5 and m is 0), or Dobanol® 91-6 (HLB=12.5 ; R is a mixture of C₉ and C₁₁ alkyl chains, n is 6 and m is 0), or Dobanol® 91-8 (HLB=13.7; R is a mixture of C₉ and C₁₁ alkyl chains, n is 8 and m is 0), Dobanol® 91 -10 (HLB=14.2; R is a mixture of C₉ to C₁₁ alkyl chains, n is 10 and m is 0), or mixtures thereof. Preferred herein are Dobanol® 91-2.5 , or Lutensol® TO3, or Lutensol® AO3, or Tergitol® 25L3, or Dobanol® 23-3, or Dobanol® 23-2, or mixtures thereof. These Dobanol® surfactants are commercially available from SHELL. These Lutensol® surfactants are commercially available from BASF and these Tergitol® surfactants are commercially available from UNION CARBIDE.

In a preferred embodiment the nonionic surfactant herein is an alkoxylated nonionic surfactant according to the formula RO—(A)ₙH, wherein: R is a C₆ to C₂₂, preferably a C₈ to C₂₂, more preferably a C₉ to C₁₄ alkyl chain, or a C₆ to C₂₈ alkyl benzene chain; A is an ethoxy or propoxy or butoxy unit; and wherein n is from 0 to 20, preferably from 1 to 15 and, more preferably from 2 to 15 even more preferably from 2 to 12 and most preferably from 4 to 10. Preferred R chains for use herein are the C₈ to C₂₂ alkyl chains. Even more preferred R chains for use herein are the C₉ to C₁₂ alkyl chains. Ethoxy/butoxylated, ethoxy/propoxylated, butoxy/propoxylated and ethoxy/butoxy/propoxylated nonionic surfactants may also be used herein. Preferred alkoxylated nonionic surfactants are ethoxylated nonionic surfactants.

Suitable alkylpolysaccharides for use herein are disclosed in U.S. Pat. No. 4,565,647, Llenado, issued Jan. 21, 1986, having a hydrophobic group containing from about 6 to about 30 carbon atoms, preferably from about 10 to about 16 carbon atoms and a polysaccharide, e.g., a polyglycoside, hydrophilic group. For acidic or alkaline cleaning compositions/solutions suitable for use in no-rinse methods, the preferred alkyl polysaccharide preferably comprises a broad distribution of chain lengths, as these provide the best combination of wetting, cleaning, and low residue upon drying. This “broad distribution” is defined by at least about 50% of the chainlength mixture comprising from about 10 carbon atoms to about 16 carbon atoms. Preferably, the alkyl group of the alkyl polysaccharide consists of a mixtures of chainlength, preferably from about 6 to about 18 carbon atoms, more preferably from about 8 to about 16 carbon atoms, and hydrophilic group containing from about one to about 1.5 saccharide, preferably glucoside, groups per molecule. This “broad chainlength distribution” is defined by at least about 50% of the chainlength mixture comprising from about 10 carbon atoms to about 16 carbon atoms. A broad mixture of chain lengths, particularly C₈-C₁₆, is highly desirable relative to narrower range chain length mixtures, and particularly versus lower (i.e., C₈-C₁₀ or C₈-C₁₂) chainlength alkyl polyglucoside mixtures. It is also found that the preferred C₈₋₁₆ alkyl polyglucoside provides much improved perfume solubility versus lower and narrower chainlength alkyl polyglucosides, as well as other preferred surfactants, including the C₈-C₁₄ alkyl ethoxylates. Any reducing saccharide containing 5 or 6 carbon atoms can be used, e.g., glucose, galactose and galactosyl moieties can be substituted for the glucosyl moieties. (optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units. The glycosyl is preferably derived from glucose.

Optionally, and less desirably, there can be a polyalkyleneoxide chain joining the hydrophobic moiety and the polysaccharide moiety. The preferred alkyleneoxide is ethylene oxide. Typical hydrophobic groups include alkyl groups, either saturated or unsaturated, branched or unbranched containing from 8 to 18, preferably from 10 to 16, carbon atoms. Preferably, the alkyl group is a straight-chain saturated alkyl group. The alkyl group can contain up to about 3 hydroxyl groups and/or the polyalkyleneoxide chain can contain up to about 10, preferably less than 5, alkyleneoxide moieties. Suitable alkyl polysaccharides are octyl, nonyidecyl, undecyidodecyl, tridecyl, tetradecyl, pentadecyl, hexadecyl, heptadecyl, and octadecyl, di-, tri-, tetra-, penta-, and hexaglucosides and/ or galatoses. Suitable mixtures include coconut alkyl, di-, tri-, tetra-, and pentaglucosides and tallow alkyl tetra-, penta- and hexaglucosides.

To prepare these compounds, the alcohol or alkylpolyethoxy alcohol is formed first and then reacted with glucose, or a source of glucose, to form the glucoside (attachment at the 1-position). The additional glycosyl units can then be attached between their 1-position and the preceding glycosyl units 2-,3-, 4-and/or 6-position, preferably predominantly the 2-position.

In the alkyl polyglycosides, the alkyl moieties can be derived from the usual sources like fats, oils or chemically produced alcohols while their sugar moieties are created from hydrolyzed polysaccharides. Alkyl polyglycosides are the condensation product of fatty alcohol and sugars like glucose with the number of glucose units defining the relative hydrophilicity. As discussed above, the sugar units can additionally be alkoxylated either before or after reaction with the fatty alcohols. Such alkyl polyglycosides are described in detail in WO 86/05199 for example. Technical alkyl polyglycosides are generally not molecularly uniform products, but represent mixtures of alkyl groups and mixtures of monosaccharides and different oligosaccharides. Alkyl polyglycosides (also sometimes referred to as “APG's”) are preferred for the purposes of the invention since they provide additional improvement in surface appearance relative to other surfactants. The glycoside moieties are preferably glucose moieties. The alkyl substituent is preferably a saturated or unsaturated alkyl moiety containing from about 8 to about 18 carbon atoms, preferably from about 8 to about 10 carbon atoms or a mixture of such alkyl moieties. C₈-C₁₆ alkyl polyglucosides are commercially available (e.g., Simusol® surfactants from Seppic Corporation, 75 Quai d'Orsay, 75321 Paris, Cedex 7, France, and Glucopon®425 available from Henkel. However, it has been found that purity of the alkyl polyglucoside can also impact performance, particularly end result for certain applications, including daily shower product technology. In the present invention, the preferred alkyl polyglucosides are those which have been purified enough for use in personal cleansing. Most preferred are “cosmetic grade” alkyl polyglucosides, particularly C₈ to C₁₆ alkyl polyglucosides, such as Plantaren 2000®, Plantaren 2000 N®, and Plantaren 2000 N UP®, available from Henkel Corporation (Postfach 101100, D 40191 Dusseldorf, Germany).

### Amphoteric/Zwitterionic Surfactant

Suitable amphoteric surfactants for use herein include amine oxides having the following formula R₁R₂R₃NO wherein each of R1, R2 and R3 is independently a saturated substituted or unsubstituted, linear or branched hydrocarbon chains of from 1 to 30 carbon atoms. Preferred amine oxide surfactants to be used according to the present invention are amine oxides having the following formula R₁R₂R₃NO wherein R1 is an hydrocarbon chain comprising from 1 to 30 carbon atoms, preferably from 6 to 20, more preferably from 8 to 16, most preferably from 8 to 12, and wherein R2 and R3 are independently substituted or unsubstituted, linear or branched hydrocarbon chains comprising from 1 to 4 carbon atoms, preferably from 1 to 3 carbon atoms, and more preferably are methyl groups. R1 may be a saturated substituted or unsubstituted linear or branched hydrocarbon chain.

Suitable amine oxides for use herein are for instance natural blend C8-C10 amine oxides as well as C12-C16 amine oxides commercially available from Hoechst and Clariant.

Suitable zwitterionic surfactants for use herein contain both cationic and anionic hydrophilic groups on the same molecule at a relatively wide range of pH's. The typical cationic group is a quaternary ammonium group, although other positively charged groups like phosphonium, imidazolium and sulfonium groups can be used. The typical anionic hydrophilic groups are carboxylates and sulfonates, although other groups like sulfates, phosphonates, and the like can be used. A generic formula for some zwitterionic surfactants to be used herein is

R₁−N⁺(R₂)(R₃)R₄X⁻

wherein R₁ is a hydrophobic group; R₂ and R₃ are each C₁-C₄ alkyl, hydroxy alkyl or other substituted alkyl group which can also be joined to form ring structures with the N; R₄ is a moiety joining the cationic nitrogen atom to the hydrophilic group and is typically an alkylene, hydroxy alkylene, or polyalkoxy group containing from 1 to 10 carbon atoms; and X is the hydrophilic group which is preferably a carboxylate or sulfonate group. Preferred hydrophobic groups R₁ are alkyl groups containing from 1 to 24, preferably less than 18, more preferably less than 16 carbon atoms. The hydrophobic group can contain unsaturation and/or substituents and/or linking groups such as aryl groups, amido groups, ester groups and the like. In general, the simple alkyl groups are preferred for cost and stability reasons.

Highly preferred zwitterionic surfactants include betaine and sulphobetaine surfactants, functionalized betaines such as acyl betaines, alkyl imidazoline alanine betaines, glycine betaines, derivatives thereof and mixtures thereof. Said betaine or sulphobetaine surfactants are preferred herein as they help disinfection by increasing the permeability of the bacterial cell wall, thus allowing other active ingredients to enter the cell.

Furthermore, due to the mild action profile of said betaine or sulphobetaine surfactants, they are particularly suitable for the cleaning of delicate surfaces, e.g., delicate laundry or surfaces in contact with food and/or babies. Betaine and sulphobetaine surfactants are also extremely mild to the skin and/or surfaces to be treated.

Suitable betaine and sulphobetaine surfactants for use herein are the betaine/sulphobetaine and betaine-like detergents wherein the molecule contains both basic and acidic groups which form an inner salt giving the molecule both cationic and anionic hydrophilic groups over a broad range of pH values. Some common examples of these detergents are described in U.S. Pat. Nos. 2,082,275, 2,702,279 and 2,255,082, incorporated herein by reference. Preferred betaine and sulphobetaine surfactants herein are according to the formula

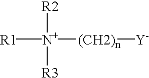

wherein R1 is a hydrocarbon chain containing from 1 to 24 carbon atoms, preferably from 8 to 18, more preferably from 12 to 14, wherein R2 and R3 are hydrocarbon chains containing from 1 to 3 carbon atoms, preferably 1 carbon atom, wherein n is an integer from 1 to 10, preferably from 1 to 6, more preferably is 1, Y is selected from the group consisting of carboxyl and sulfonyl radicals and wherein the sum of R1, R2 and R3 hydrocarbon chains is from 14 to 24 carbon atoms, or mixtures thereof.

Examples of particularly suitable betaine surfactants include C₁₂-C₁₈ alkyl dimethyl betaine such as coconut-betaine and C₁₀-C₁₆ alkyl dimethyl betaine such as laurylbetaine. Coconutbetaine is commercially available from Seppic under the trade name of Amonyl 265®. Laurylbetaine is commercially available from Albright & Wilson under the trade name Empigen BB/L®.

Other specific zwitterionic surfactants have the generic formulas:

R₁—C(O)—N(R₂)—(C(R₃)₂)ₙ—N(R₂)₂⁽⁺⁾—(C(R₃)₂)ₙ—SO₃⁽⁻⁾

or

R₁—C(O)—N(R₂)—(C(R₃)₂)ₙ—N(R₂)₂⁽⁺⁾—(C(R₃)₂)ₙ—COO⁽⁻⁾

wherein each R₁ is a hydrocarbon, e.g. an alkyl group containing from 8 up to 20, preferably up to 18, more preferably up to 16 carbon atoms, each R₂ is either a hydrogen (when attached to the amido nitrogen), short chain alkyl or substituted alkyl containing from one to 4 carbon atoms, preferably groups selected from the group consisting of methyl, ethyl, propyl, hydroxy substituted ethyl or propyl and mixtures thereof, preferably methyl, each R₃ is selected from the group consisting of hydrogen and hydroxy groups and each n is a number from 1 to 4, preferably from 2 to 3, more preferably 3, with no more than one hydroxy group in any (C(R₃)₂) moiety. The R₁ groups can be branched and/or unsaturated. The R₂ groups can also be connected to form ring structures. A surfactant of this type is a C₁₀-C₁₄ fatty acylamidopropylene(hydroxypropylene)sulfobetaine that is available from the Sherex Company under the trade name “Varion CAS sulfobetaine”®.

### PeroxVqen Bleach

The compositions according to the present invention may comprise a peroxygen bleach as an optional feature.

A preferred peroxygen bleach is hydrogen peroxide, or a water soluble source thereof, or mixtures thereof. As used herein a hydrogen peroxide source refers to any compound which produces hydrogen peroxide when said compound is in contact with water. Suitable water-soluble sources of hydrogen peroxide for use herein include percarbonates, persilicates, persulphates such as monopersulfate, perborates and peroxyacids such as diperoxydodecandioic acid (DPDA), magnesium perphthalic acid and mixtures thereof.

In addition, other classes of peroxides can be used as an alternative to hydrogen peroxide and sources thereof or in combination with hydrogen peroxide and sources thereof. Suitable classes include dialkylperoxides, diacylperoxides, preformed percarboxylic acids, organic and inorganic peroxides and/or hydroperoxides. The most preferred peroxygen bleach is hydrogen peroxide.

The presence of said peroxygen bleach especially hydrogen peroxide, persulfate and the like, in the compositions according to the present invention can contribute to disinfection properties of said compositions. Indeed, said peroxygen bleach may attack the vital function of the micro-organism cells, for example, it may inhibit the assembling of ribosomes units within the cytoplasm of the microorganisms cells. Also said peroxygen bleach like hydrogen peroxide, is an oxidiser that generates hydroxyl free radicals which attack proteins and nucleic acids. Furthermore, the presence of said peroxygen bleach, especially hydrogen peroxide, provides strong stain removal benefits which are particularly noticeable for example in laundry and hard surfaces applications.

Typically, peroxygen bleach or a mixture thereof is present in the compositions according to the present invention at a level of at least 0.01% by weight of the total composition, preferably from 0.1% to 15%, and more preferably from 1% to 10%.

### Essential Oils

Another preferred component of the compositions of the present invention is an antimicrobial essential oil or an active thereof, or a mixture thereof.

Suitable antimicrobial essential oils to be used herein are those essential oils which exhibit antimicrobial activity. By “actives of essential oils”, it is meant herein any ingredient of essential oils or natural extracts that exhibit antimicrobial activity. It is speculated that said antimicrobial essential oils and actives thereof act as proteins denaturing agents. Also said antimicrobial oils and actives thereof are compounds which contribute to the safety profile of a composition comprising them when it is used to disinfect any surface. A further advantage of said antimicrobial oils and actives thereof is that they impart pleasant odor to a composition comprising them without the need of adding a perfume.

Such antimicrobial essential oils include, but are not limited to, those obtained from thyme, lemongrass, citrus, lemons, oranges, anise, clove, aniseed, pine, cinnamon, geranium, roses, mint, lavender, citronella, eucalyptus, peppermint, camphor, ajowan, sandalwood, rosmarin, vervain, fleagrass, lemongrass, ratanhiae, cedar, origanum, cypressus, propolis extracts and mixtures thereof. Preferred antimicrobial essential oils to be used herein are thyme oil, clove oil, cinnamon oil, geranium oil, eucalyptus oil, peppermint oil, citronella oil, ajowan oil, mint oil, origanum oil, propolis, cypressus oil cedar , garlic extract or mixtures thereof.

Actives of essential oils to be used herein include, but are not limited to, thymol (present for example in thyme, ajowan), eugenol (present for example in cinnamon and clove), menthol (present for example in mint), geraniol (present for example in geranium and rose, citronella), verbenone (present for example in vervain), eucalyptol and pinocarvone (present in eucalyptus), cedrol (present for example in cedar), anethol (present for example in anise), carvacrol, hinokitiol, berberine, ferulic acid, cinnamic acid, methyl salicylic acid, methyl salycilate, terpineol, limonene and mixtures thereof. Preferred actives of essential oils to be used herein are thymol, eugenol, verbenone, eucalyptol, terpineol, cinnamic acid, methyl salicylic acid, limonene, geraniol, ajolene or mixtures thereof.

Thymol may be commercially available for example from Aldrich, eugenol may be commercially available for example from Sigma, Systems-Bioindustries (SBI)-Manheimer Inc.

Typically, the antimicrobial essential oil or active thereof or mixture thereof is present in the composition at a level of at least 0.001% by weight of the total composition, preferably from 0.006% to 10%, more preferably from 0.01% to 8% and most preferably of from 0.03% to 3%.

It has now been found that combining said antimicrobial essential oil or an active thereof or a mixture thereof with a peroxygen bleach, in a composition, delivers not only excellent immediate disinfecting properties to the surfaces treated with said composition, but also long lasting disinfecting properties. Indeed, it is speculated that peroxygen bleach and said essential oils/actives adsorb on a surface having been treated with said composition and thus reduce or even prevent the contamination of microorganisms over time, typically up to 48 hours after the surface has been treated with said composition, thereby delivering long lasting disinfection. In other words, it is speculated that a microfilm of said active ingredients is deposited on the surface treated with said compositions allowing protection against microorganisms recontamination overtime. Advantageously, this long lasting disinfection benefits is obtained with the compositions of the present invention comprising peroxygen bleach and antimicrobial essential oils/actives even when used under highly diluted conditions, i.e., up to dilution levels of from 1:100 (composition:water).

Excellent long lasting disinfection is obtained by treating a surface with a composition comprising a peroxygen bleach and an antimicrobial essential oil or active thereof as described herein, on a variety of microorganisms, e.g., the growth of Gram positive bacteria like Staphylococcus aureus, and Gram negative bacteria like Pseudomonas aeroginosa as well as of fungi like Candida albicans is reduced or even prevented on a surface having been treated with said composition.

Long lasting disinfection properties of the compositions herein may be measured by the bactericidal activity of said compositions. A test method suitable to evaluate the long lasting bactericidal activity of a composition may be as follow: First, the surfaces (e.g. glass) to be tested are respectively treated with either a composition according to the present invention or a reference composition, e.g., a negative control composed of pure water (for example by spraying the composition directly on the surface or first spraying the composition on a sponge used to clean the surface or when the composition herein is executed in the form of wipe by wiping the surface therewith). After a variable time frame (e.g. 24 hours) each surface is respectively inoculated with bacteria (10⁶⁻⁷ cfu/slide) cultured in for example TSB (Tryptone Soya Broth) and left typically from a few seconds to 2 hours before evaluating the remaining living bacteria. Then living bacteria (if any) are recovered from the surface (by touching TSA+neutraliser plates and by re-suspending the bacteria into the neutralisation broth and plating them on agar) and incubated at appropriate temperature, e.g. 37° C. to let them grow typically over night. Finally, a visual grading of the living bacteria is made by comparing side by side the cultures and/or dilutions thereof (e.g. 10⁻² or 10⁻¹) resulting from the surfaces treated with the compositions according to the present invention and the reference composition.

In a particular embodiment of the present invention, depending on the end use desired with said compositions they may further comprise, as optional ingredients, other antimicrobial compounds that further contribute to the antimicrobial/antibacterial activity of the compositions according to the present invention. Such antimicrobial ingredients include parabens like ethyl paraben, propyl paraben, methyl paraben, glutaraldehyde or mixtures thereof.

### Additional Surfactants

The compositions of the present invention may comprise an additional surfactant. The additional surfactant may be selected from other nonionic, amphoteris, zwitterionic or anionic surfactants including but not limited to those described above. Alternatively the additional surfactant may include for example a cationic surfactant or a C6-C20 conventional soaps (alkali metal salt of a C6-C20 fatty acid, preferably sodium salts).

### Chelating Agent

The compositions herein may further comprise a chelating agent as a preferred optional ingredient. Suitable chelating agents may be any of those known to those skilled in the art such as the ones selected from the group comprising phosphonate chelating agents, aminophosphonate chelating agents, substituted heteroaromatic chelating agents, amino carboxylate chelating agents, other carboxylate chelating agents, polyfunctionally-substituted aromatic chelating agents, biodegradable chelating agents like ethylene diamine N,N′-disuccinic acid, or mixtures thereof.

Suitable phosphonate chelating agents to be used herein include etidronic acid (1-hydroxyethylene-diphosphonic acid (HEDP)), and/or alkali metal ethane 1-hydroxydiphosphonates.

Suitable amino phosphonate chelating agents to be used herein include amino alkylene poly (alkylene phosphonates), nitrilotris(methylene)triphosphonates, ethylene diamine tetra methylene phosphonates, and/or diethylene triamine penta methylene phosphonates. Preferred aminophosphonate chelating agents to be used herein are diethylene triamine penta methylene phosphonates.

These phosphonate/amino phosphonate chelating agents may be present either in their acid form or as salts of different cations on some or all of their acid functionalities. Such phosphonate/amino phosphonate chelating agents are commercially available from Monsanto under the trade name DEQUEST®.

Substituted heteroaromatic chelating agents to be used herein include hydroxypiridine-N-oxide or a derivative thereof.

Suitable hydroxy pyridine N-oxides and derivatives thereof to be used according to the present invention are according to the following formula:

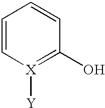

wherein X is nitrogen, Y is one of the following groups oxygen, —CHO, —OH, —(CH2)n-COOH, wherein n is an integer of from 0 to 20, preferably of from 0 to 10 and more preferably is 0, and wherein Y is preferably oxygen. Accordingly particularly preferred hydroxy pyridine N-oxides and derivatives thereof to be used herein is 2-hydroxy pyridine N-oxide. Hydroxy pyridine N-oxides and derivatives thereof may be commercially available from Sigma.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy -3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4, 704, 233, Nov. 3, 1987 to Hartman and Perkins. Ethylenediamine N,N′-disuccinic acid is, for instance, commercially available under the tradename ssEDDS® from Palmer Research Laboratories. Ethylene diamine N,N′-disuccinic acid is particularly suitable to be used in the compositions of the present invention.

Suitable amino carboxylate chelating agents useful herein include ethylene diamine tetra acetates, diethylene triamine pentaacetates, diethylene triamine pentoacetate (DTPA), N-hydroxyethylethylenediamine triacetates, nitrilotri-acetates, ethylenediamine tetraproprionates, triethylenetetraaminehexa-acetates, ethanoldiglycines, propylene diamine tetracetic acid (PDTA) and methyl glycine di-acetic acid (MGDA), both in their acid form, or in their alkali metal, ammonium, and substituted ammonium salt forms. Particularly suitable to be used herein are diethylene triamine penta acetic acid (DTPA), propylene diamine tetracetic acid (PDTA) which is, for instance, commercially available from BASF under the trade name Trilon FS® and methyl glycine di-acetic acid (MGDA).

Further carboxylate chelating agents to be used herein includes malonic acid, salicylic acid, glycine, aspartic acid, glutamic acid, or mixtures thereof.

Typically, the compositions according to the present invention comprise up to 5% by weight of the total composition of a chelating agent, or mixtures thereof, preferably from 0.01% to 3% by weight and more preferably from 0.01% to 1.5%.

### Radical Scavenger

The compositions herein may comprise a radical scavenger as another optional ingredient. Suitable radical scavengers for use herein include the well-known substituted mono and di hydroxy benzenes and derivatives thereof, alkyl- and aryl carboxylates and mixtures thereof. Preferred radical scavengers for use herein include di-tert-butyl hydroxy toluene (BHT), p-hydroxy-toluene, hydroquinone (HQ), di-tert-butyl hydroquinone (DTBHQ), mono-tert-butyl hydroquinone (MTBHQ), tert-butyl-hydroxy anysole (BHA), p-hydroxy-anysol, benzoic acid, 2,5-dihydroxy benzoic acid, 2,5-dihydroxyterephtalic acid, toluic acid, catechol, t-butyl catechol, 4-allyl-catechol, 4-acetyl catechol, 2-methoxy-phenol, 2-ethoxy-phenol, 2-methoxy-4-(2-propenyl)phenol, 3,4-dihydroxy benzaldehyde, 2,3-dihydroxy benzaldehyde, benzylamine, 1,1,3-tris(2-methyl-4-hydroxy-5-t-butylphenyl) butane, tert-butyl-hydroxy-anyline, p-hydroxy anyline as well as n-propyl-gallate. Highly preferred for use herein are di-tert-butyl hydroxy toluene, which is for example commercially available from SHELL under the trade name IONOL CP® and/or tert-butyl-hydroxy anysole. These radical scavengers further contribute to the stability of the peroxygen bleach-containing compositions herein.

Typically, the compositions according to the present invention comprise up to 5% by weight of the total composition of a radical scavenger, or mixtures thereof, preferably from 0.002% to 1.5% by weight and more preferably from 0.002% to 1%.

### Solvent

The compositions herein may comprise as a preferred optional ingredient a solvent or mixtures thereof. When used, solvents will, advantageously, give an enhanced cleaning to the compositions herein. Suitable solvents for incorporation in the compositions according to the present invention include propylene glycol derivatives such as n-butoxypropanol or n-butoxypropoxypropanol, water-soluble CARBITOL® solvents or water-soluble CELLOSOLVE® solvents. Water-soluble CARBITOL® solvents are compounds of the 2-(2-alkoxyethoxy)ethanol class wherein the alkoxy group is derived from ethyl, propyl or butyl. A preferred water-soluble carbitol is 2-(2-butoxyethoxy)ethanol also known as butyl carbitol. Water-soluble CELLOSOLVE® solvents are compounds of the 2-alkoxyethoxyethanol class, with 2-butoxyethoxyethanol being preferred. Other suitable solvents are benzyl alcohol, methanol, ethanol, isopropyl alcohol and diols such as 2-ethyl-1,3-hexanediol and 2,2,4-trimethyl-1,3-pentanediol and mixture thereof. Preferred solvents for use herein are n-butoxypropoxypropanol, butyl carbitol®, benzyl alcohol, isopropanol, 1-propanol and mixtures thereof. Most preferred solvents for use herein are butyl carbitol®, benzyl alcohol, 1 -propanol and/or isopropanol.

The solvents may typically be present within the compositions according to the invention at a level up to 15% by weight, preferably from 0.5% to 7% by weight of the composition.

### pH Buffer

In the embodiment of the present invention wherein the compositions are formulated in the alkaline pH range, typically from 7.5 to 12, the compositions according to the present invention may further comprise a pH buffer or a mixture thereof, i.e. a system composed of a compound or a combination of compounds, whose pH changes only slightly when a strong acid or base is added.

Suitable pH buffers for use herein include borate pH buffer, phosphonate, silicate and mixtures thereof. Suitable borate pH buffers for use herein include alkali metal salts of borates and alkyl borates and mixtures thereof. Suitable borate pH buffers to be used herein are alkali metal salts of borate, metaborate, tetraborate, octoborate, pentaborate, dodecaboron, borontrifluoride and/or alkyl borate containing from 1 to 12 carbon atoms, and preferably from 1 to 4. Suitable alkyl borate includes methyl borate, ethyl borate and propyl borate. Particularly preferred herein are the alkali metal salts of metaborate (e.g. sodium metaborate), tetraborate (e.g., sodium tetraborate decahydrate) or mixtures thereof.

Boron salts like sodium metaborate and sodium tetraborate are commercially available from Borax and Societa Chimica Larderello under the trade name sodium metaborate® and Borax®.

The pH of the composition can also be adjusted to an acidic pH and/or buffered at that pH using any suitable acidifying agent, for example organic acids.

Typically, the compositions according to the present invention may comprise up to 15% by weight of the total composition of a pH buffer, or mixtures thereof, preferably from 0.01% to 10%, more preferably from 0.01% to 5% and most preferably from 0. 1 % to 3%.

### Packaging Form of the Wet Wipes

In a preferred embodiment according to the present invention, the wet wipes are packaged in the container in any convenient configuration which allows easy removal of a single or multiple wet wipe from the container. Preferably the wipes are packaged in rolls, stacks or piles. More preferably the wipes are provided in a stacked configuration which may comprise any number of wipes. Typically, the stack comprises from 2 to 150, more preferably from 5 to 100, most preferably from 10 to 60 wipes. Moreover the wipes may be provided folded or unfolded. Most preferably, the wipes are stacked in a folded configuration.

### Process of Treating a Surface

In a preferred embodiment, the present invention encompasses a process of cleaning and/or disinfecting a surface, preferably a hard surface, comprising the step of contacting, preferably wiping, said surface with a substrate which incorporates a composition as described herein.

In a preferred embodiment of the present application, said process comprises the steps of contacting parts of said surface, more preferably soiled parts of said surface, with said substrate which incorporates a composition as described herein.

In another preferred embodiment said process, after contacting said surface with said substrate which incorporates a composition as described herein, further comprises the step of imparting mechanical action to said surface using said substrate which incorporates a composition as described herein. By “mechanical action” it is meant herein, agitation of the wet wipe on the surface, as for example rubbing the surface using the wet wipe.

By “surface”, it is meant herein any surface including animate surface like human skin, mouth, teeth, and inanimate surfaces. Inanimate surfaces include, but are not limited to, hard-surfaces typically found in houses like kitchens, bathrooms, or in car interiors, e.g., tiles, walls, floors, chrome, glass, smooth vinyl, any plastic, plastified wood, table top, sinks, cooker tops, dishes, sanitary fittings such as sinks, showers, shower curtains, wash basins, WCs and the like, as well as fabrics including clothes, curtains, drapes, bed linens, bath linens, table cloths, sleeping bags, tents, upholstered furniture and the like, and carpets. Inanimate surfaces also include household appliances including, but not limited to, refrigerators, freezers, washing machines, automatic dryers, ovens, microwave ovens, dishwashers and so on.

What is claimed is:

1. A continuous length of substrate comprising a plurality of wipes suitable for use in a pop-up dispensing system, each wipe comprising two opposing sides and two opposing ends joining said two opposing sides, said wipes having a longitudinal direction which extends between said sides and a cross direction which is perpendicular to the longitudinal direction, each wipe being connected to a subsequent wipe by a connecting section defined by a tear perforation pattern, characterised in that the length of substrate is folded in the longitudinal direction and then in the cross direction in a zig-zag, overlaid, pattern to define a stack of wipes.

2. A continuous length of substrate according to claim 1 wherein the length of substrate is folded in the longitudinal direction using folding patterns selected from the group consisting of Z, V, and C folding patterns.

3. A continuous length of substrate according to claim 1 wherein the substrate comprises more than 80% man-made fibres.

4. A continuous length of substrate according to claim 3 wherein the substrate comprises more than 95% man-made fibres.

5. A continuous length of substrate according to claim 1 wherein the man-made fibres are substantially 100% hydroentangled man-made regenerated cellulosic fibres.

6. A continuous length of substrate according to claim 1 wherein the wipe is of substantially rectangular shape.

7. A continuous length of substrate according to claim 1 wherein the perforation pattern is defined by a series of spaced slits through the substrate.

8. A continuous length of substrate according to claim 1 wherein the perforation pattern consists of only one connecting section.

9. A continuous length of substrate according to claim 1 wherein the wipe incorporates a cleaning composition.

10. A pop-up wipe dispensing system comprising a container which comprises a dispensing orifice, and a continuous length of substrate according to claim 1.

11. A pop-up wipe dispensing system according to claim 10 wherein the container has length and width dimension less than the length and width dimensions of each unfolded wipe.

12. A pop-up wipe dispensing system according to claim 10 wherein the container comprises side, bottom, and top walls wherein the dispensing orifice is located in the top wall.

13. A pop-up wipe dispensing system according to claim 10 wherein the continuous length of substrate is located in a pouch within the container.

14. A pop-up wipe dispensing system according to claim 13 wherein the container and/or the pouch is sealable and resealable.
